(19) United States
(12) Patent Application Publication
(10) Pub. No.: US 2025/0338993 A1
(43) Pub. Date: Nov. 6, 2025

(54) Cookware Strainer Device for Controlled Liquid Dispensing

(71) Applicant: Ashley Curell, Montrose, CO (US)

(72) Inventor: Ashley Curell, Montrose, CO (US)

(21) Appl. No.: 19/198,185

(22) Filed: May 5, 2025

Related U.S. Application Data
(60) Provisional application No. 63/642,148, filed on May 3, 2024.

(51) Int. Cl. A47J 36/08

(52) U.S. Cl. CPC A47J 36/08

(57) ABSTRACT

A cookware system which includes a pan and a strainer lid to safely and efficiently drain hot liquids without removing the lid is disclosed. The strainer lid comprises a transparent disk with a heat-resistant peripheral rim that seals to the top of the pan, preventing spillage. A central twist knob is rotatably mounted on the lid and connected to a pivot arm positioned beneath the disk. The pivot arm extends to a cavity within the rim, where the pivot arm controls a strainer cover that aligns with or blocks a set of strainer holes embedded in the rim. By rotating the knob, the user can selectively open or close the strainer to control liquid flow. The system enables controlled draining of liquids, such as water or grease, while retaining food inside the pan, thereby improving user safety by minimizing contact with steam or splashing liquid during cooking.

### CROSS-REFERENCE TO RELATED APPLICATION

The present application claims priority to, and the benefit of, U.S. Provisional Application No. 63/642,148 which was filed on May 3, 2024, and is incorporated herein by reference in its entirety.

### FIELD OF THE INVENTION

The present invention generally relates to kitchen cookware and, more specifically, related to a strainer lid assembly configured for safe, controlled liquid drainage from a cooking pan without requiring lid removal. The invention comprises a transparent, disk-shaped lid with a heat-resistant sealing rim that fits snugly on various cookware. A centrally mounted twist knob is operatively connected to a pivot arm beneath the lid, which rotates a strainer cover within the rim to open or close a set of straining holes. The invention enables users to drain hot liquids such as water, broth, or grease while retaining food securely within the pan. Further, the invention eliminates the need to tilt or lift the lid, reducing the risk of spills and steam burns. Accordingly, the present disclosure makes specific reference thereto. Nonetheless, it is to be appreciated that aspects of the present invention are also equally applicable to other like applications, devices, and methods of manufacture.

### BACKGROUND

By way of background, cooking often involves the use of liquids such as water, oil, or broth, that must be drained or separated from solid food at various stages of the food preparation process. A common example is draining water after boiling pasta or removing excess grease from sautéed or fried foods. Traditionally, removing liquid requires the cook to tilt a hot, often heavy, pan over a sink while simultaneously holding the lid partially open to enable the liquid to escape without losing food contents. The conventional method is not only inconvenient but also inherently hazardous.

Trying to pour off cooking water from a heavy pot of pasta, or removing grease from a full pan of food, can be a dangerous balancing act, with hot liquids and unstable contents potentially leading to spills and severe burns. In many cases, such a task requires both hands, making it difficult for users with limited mobility or strength, and increasing the risk of injury due to slipping lids or uncontrolled splashing. While some cookware products include strainers or vented lids, they typically do not enable for fully controlled opening and closing of the straining mechanism during cooking. Many such lids also require removal or manual repositioning to drain liquid, which exposes users to hot steam or splattering oil. Individuals desire a safe, efficient, and user-friendly solution that enables controlled draining of hot liquids from a pan without removing the lid or requiring complex operations.

Therefore, there exists a long-felt need in the art for a cookware strainer lid that enables for the safe, controlled draining of hot liquids from a pan without requiring removal of the lid. There is a long-felt need for a lid assembly that reduces the risk of burns, steam exposure, and spills during the straining process. Additionally, there is a long-felt need for a strainer lid that can be securely sealed onto pans of various sizes and shapes. Furthermore, there is a long-felt need for a user-friendly lid that enables one-handed operation and enhances kitchen safety and cooking efficiency. More specifically, there is a long-felt need for a transparent, heat-resistant, and ergonomically configured lid that offers control of liquid drainage. Finally, there is a long-felt need in the art for a strainer lid and pan assembly that enhances cooking usability while preventing accidental spills and food loss during the draining process.

The subject matter disclosed and claimed herein, in one embodiment, comprises a cookware strainer lid for selectively opening and closing a strainer vent. The strainer lid comprises a transparent disk-shaped lid body formed from a heat-resistant material such as tempered glass. A thick, heat-insulated rim is disposed along the periphery of the lid to provide a snug, sealing fit on a pan. A twist knob is rotatably mounted at the center of the lid and operatively connected to a pivot arm located beneath the lid. The pivot arm extends radially from the knob to the rim, terminating in a strainer cover housed within a cavity in the rim. A series of strainer holes is disposed adjacent the rim, and the strainer cover is rotatable via the twist knob to move between an open position for draining and a closed position to seal the strainer.

In another embodiment, the cookware strainer lid is configured to be used in combination with a standard cooking pan. The rim of the lid is dimensioned to fit securely on a variety of cookware styles, creating a tight seal that remains stable during tilting or pouring. The twist knob is constructed from a heat-resistant material such as silicone to facilitate safe handling, while the pivot arm and strainer cover are configured to operate smoothly under high temperatures.

In this manner, the cookware strainer lid and pan system of the present invention fulfills the long-felt need for a safe, intuitive, and efficient method to strain hot liquids during cooking. The lid assembly enhances kitchen safety by eliminating the need to juggle pots and lids over sinks or drains, thereby reducing accidents related to spills and steam exposure. The invention provides a reliable, mess-free alternative to traditional straining methods, improving convenience for users in home kitchens, commercial food preparation, or even outdoor cooking scenarios. The invention offers a practical, scalable solution compatible with modern cookware designs, and can be manufactured using durable, food-safe materials to meet industry standards and user expectations.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a cookware strainer lid. The lid comprises a lid body made of a transparent material and having a peripheral rim configured to snugly fit onto a pan to create a seal, a twist knob is disposed at a center portion of the lid body and configured to rotate 360 degrees, a pivot arm is operatively coupled to the twist knob and extends toward the peripheral rim, a strainer is disposed within the peripheral rim, the strainer includes a plurality of strainer holes, a strainer cover is connected to a distal end of the pivot arm, the strainer cover being disposed within a cavity in the rim and is configured to move between an open position enabling fluid to flow through the strainer holes and a closed position sealing the strainer holes, wherein rotation of the twist knob causes the pivot arm to rotate the strainer cover between the open and closed positions without removing the lid body from the pan.

In another aspect, a liquid-draining lid assembly for cookware is disclosed. The assembly comprises a disk having an upper surface and a lower surface, the disk includes a heat-resistant peripheral rim configured to engage a top edge of a pan, a twistable central knob is mounted in an aperture at a center of the disk, the knob is configured to rotate 360 degrees, an axle connects the knob to a pivot arm, the pivot arm is disposed beneath the disk and extends radially toward the rim, a strainer section is formed in a portion of the rim and has a plurality of openings for draining liquid, a movable strainer cover is mounted at an end of the pivot arm and is positioned within a cavity in the rim, wherein rotation of the knob actuates the pivot arm to move the strainer cover into and out of alignment with the strainer section to control the flow of liquid from the cookware.

In another embodiment, a cooking apparatus is disclosed and comprises a pan having a base, a sidewall extending upward from the base, and a handle extending outward from the sidewall. A strainer lid is configured to be removably secured to an open top of the pan, the strainer lid comprises a transparent disk-shaped lid body, a peripheral rim made of a heat-resistant material and configured to provide a snug, sealing fit with an upper edge of the sidewall of the pan, a central twist knob is rotatably mounted at a center of the disk-shaped lid body, a pivot arm is operatively coupled to the twist knob and extends beneath the disk-shaped lid body toward the rim, a strainer is integrated into a portion of the rim, the strainer comprises a plurality of holes for draining liquid, a strainer cover is disposed within a cavity of the rim and connected to a distal end of the pivot arm, and wherein rotation of the twist knob actuates the pivot arm to move the strainer cover between a closed position sealing the strainer holes and an open position exposing the strainer holes to permit draining of liquid from the pan without removing the strainer lid.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of a cookware strainer lid of the present invention in accordance with the disclosed structure;

FIG. 2 illustrates an exploded view of the cookware strainer lid of the present invention in accordance with the disclosed structure;

FIG. 3 illustrates a side view showing the position of the pivot arm underneath the glass disk and rim being secured to a pan in accordance with the disclosed structure;

FIG. 4 illustrates a perspective view showing the cookware strainer lid being used with a pan in accordance with one embodiment of the present invention;

FIG. 5 illustrates a flow chart depicting a process of using the pan with the strainer lid for cooking and straining liquid in accordance with one embodiment of the present invention; and

FIG. 6 illustrates a perspective view showing a user using the pan with the strainer lid to pour out liquid from the pan without removing the lid in accordance with one embodiment of the present invention.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a cookware strainer lid that enables for the safe, controlled draining of hot liquids from a pan without requiring removal of the lid. There is a long-felt need for a lid assembly that reduces the risk of burns, steam exposure, and spills during the straining process. Additionally, there is a long-felt need for a strainer lid that can be securely sealed onto pans of various sizes and shapes. Furthermore, there is a long-felt need for a user-friendly lid that enables one-handed operation and enhances kitchen safety and cooking efficiency. More specifically, there is a long-felt need for a transparent, heat-resistant, and ergonomically configured lid that offers control of liquid drainage. Finally, there is a long-felt need in the art for a strainer lid and pan assembly that enhances cooking usability while preventing accidental spills and food loss during the draining process.

The present invention, in one exemplary embodiment, is a cooking apparatus that comprises a pan having a base, a sidewall extending upward from the base, and a handle extending outward from the sidewall. A strainer lid is configured to be removably secured to an open top of the pan, the strainer lid comprises a transparent disk-shaped lid body, a peripheral rim made of a heat-resistant material and configured to provide a snug, sealing fit with an upper edge of the sidewall of the pan, a central twist knob is rotatably mounted at a center of the disk-shaped lid body, a pivot arm is operatively coupled to the twist knob and extends beneath the disk-shaped lid body toward the rim, a strainer is integrated into a portion of the rim, the strainer comprises a plurality of holes for draining liquid, a strainer cover is disposed within a cavity of the rim and connected to a distal end of the pivot arm, and wherein rotation of the twist knob actuates the pivot arm to move the strainer cover between a closed position sealing the strainer holes and an open position exposing the strainer holes to permit draining of liquid from the pan without removing the strainer lid.

Reference will now be made in detail to the present preferred embodiments of the invention, examples of which are illustrated in the accompanying drawings. Wherever possible, the same reference numerals are used in the drawings and the description to refer to the same or like parts.

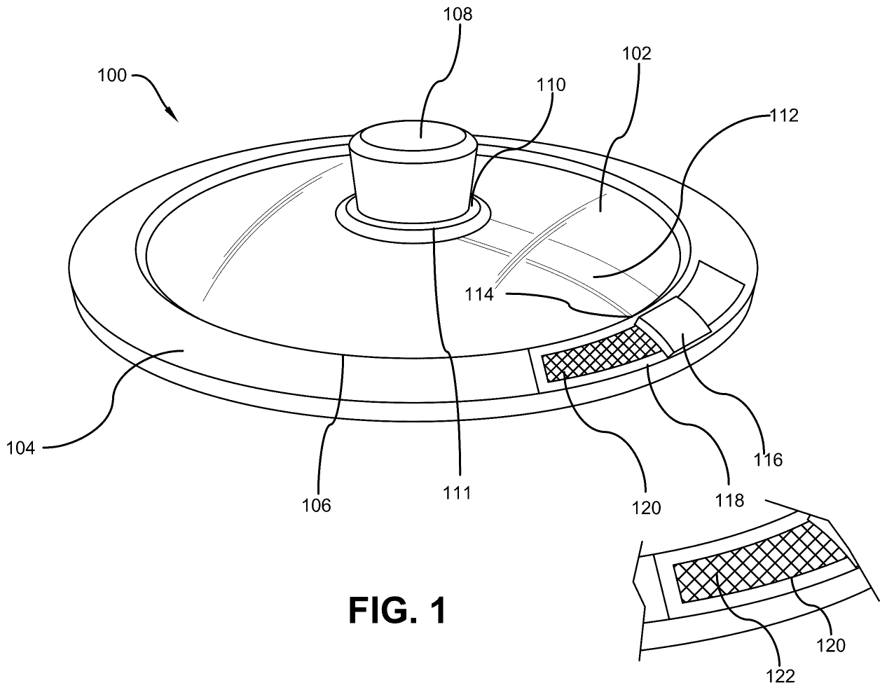

Referring initially to the drawings, FIG. 1 illustrates a perspective view of a cookware strainer lid of the present invention in accordance with the disclosed structure. The cookware strainer lid 100 of the present invention is configured to enable safe, controlled draining of hot liquids while keeping solids (i.e., food) inside a pan, without requiring lid removal. The cookware strainer lid 100 can be configured to fit cookware of different sizes and shapes and can also be made from various materials. More specifically, the cookware strainer lid 100 includes a lid body or lid body or disk 102 which is preferably made of a transparent material, such as glass, and has a thick protective rim 104 disposed along the periphery 106 of the lid body or disk 102. The thick protective rim 104 is configured to secure to a pan for a snug or sealable fit on the pan, thereby creating a seal to keep contents of the pan from spilling during pouring of the hot liquids, grease, and more.

A twist knob 108 is disposed at the center 110 of the lid body or disk 102 and is configured to turn bi-directionally 360 degrees. The twist knob 108 is preferably made from a heat-resistant material such as silicone or any other similar material for safe handling of the knob 108 and is disposed in an aperture 111 at the center 110 of the lid body or disk 102. A pivot arm 112 is operatively connected to the twist knob 108 and extends from the twist knob 108 to the rim 104. The distal end 114 of the pivot arm 112 has a strainer cover 116 which is configured to be accommodated adjacent to an inside surface of the rim 104. The strainer cover 116 is configured to rotatably move inside a cavity 118 disposed adjacent the rim 104 upon rotation of the twist knob 108.

A strainer 120 is disposed in the rim 104 and includes a plurality of strainer holes 122. The strainer holes 122 are used for pouring liquid out, and for enabling escape of steam, from a pan while the strainer lid 100 is secured to the pan. The strainer cover 116 is configured to selectively align with the strainer 120 to seal the strainer 120, thereby preventing steam or liquid from escaping. When the knob 108 is turned to rotate the strainer cover 116 away from the strainer 120, then, hot liquid can be poured out safely. The strainer lid 100 eliminates the requirement of lifting the lid 100 to pour out hot liquid and further, prevents burns from steam or splashing grease.

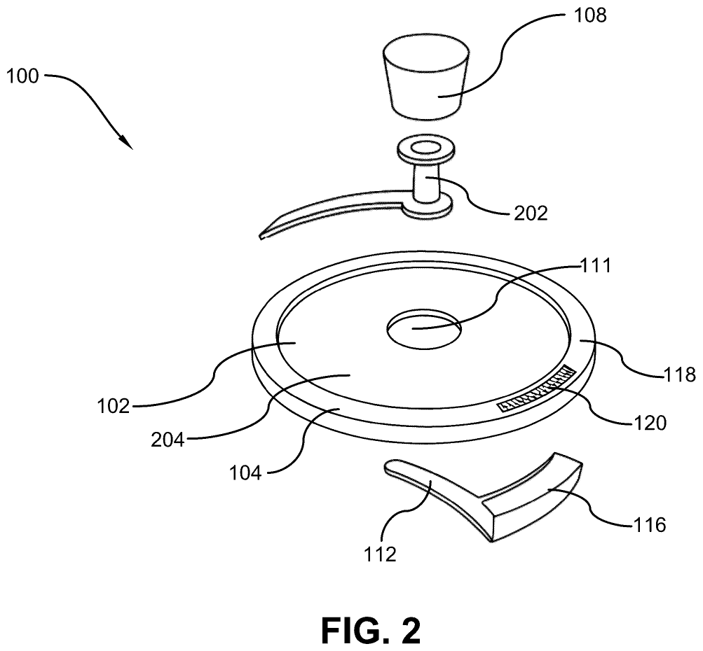

FIG. 2 illustrates an exploded view of the cookware strainer lid of the present invention in accordance with the disclosed structure. As illustrated, the twist knob 108 includes an axle 202 accommodated within the twist knob 108. The axle 202 secures the twist knob 108 to the lid 102 and provides the pivot for rotating motion of the twist knob 108 and the coupled pivot arm 112. The pivot arm 112 is disposed underneath the lid body or disk 102 such that the upper surface 204 of the lid body or disk 102 remains planar and unobstructive. The strainer cover 116 is dimensioned to selectively align with the strainer 120 such that upon rotation, the strainer cover 116 aligns with the strainer 120 and seals the strainer 120 to prevent the liquid from pouring out. The strainer 120 can be disposed at any strategic location within the rim 104 and can also be configured based on the type of cookware to be used with the cookware strainer lid 100.

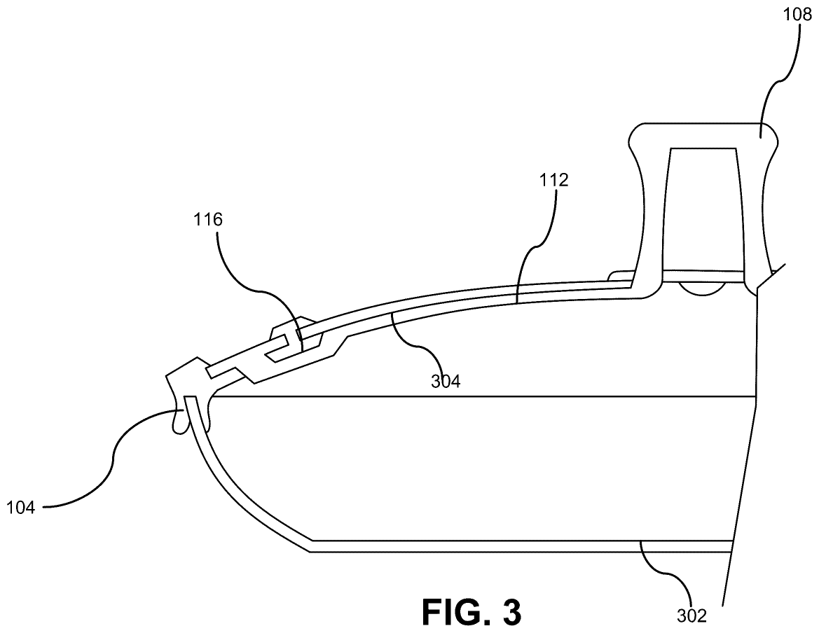

FIG. 3 illustrates a side view showing the position of the pivot arm underneath the glass disk and rim being secured to a pan in accordance with the disclosed structure. The rim 104 of the lid 100 is configured to provide a snug or sealable fit to the pan 302 to prevent unintentional movement of the lid 100 during use thereof. The pivot arm 112 touches the bottom surface 304 of the lid body or disk 102 and is operatively coupled to the knob 108. The strainer cover 116 is adapted to move along the rim 104 upon rotation of the knob 108 for opening and closing the strainer 120 for enabling pouring of liquid from the pan 302 without removing the lid 100.

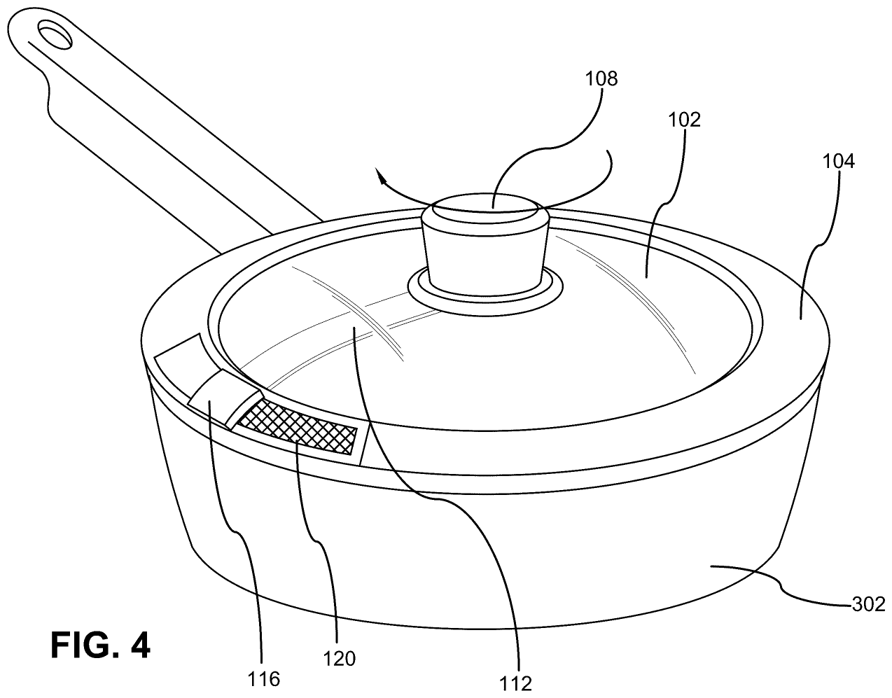

FIG. 4 illustrates a perspective view showing the cookware strainer lid being used with a pan in accordance with one embodiment of the present invention. The pan 302 can be any conventional cookware and the strainer lid 100 is placed on the pan 302 to protect the food items stored inside the pan 302. The knob 108 can be used to rotate the pivot arm 112 to access the strainer 120 (as illustrated in FIG. 4). Using the strainer lid 100, the liquid or grease from the pan 302 can be poured out from the strainer 120 without removing the lid 100 from the pan 302.

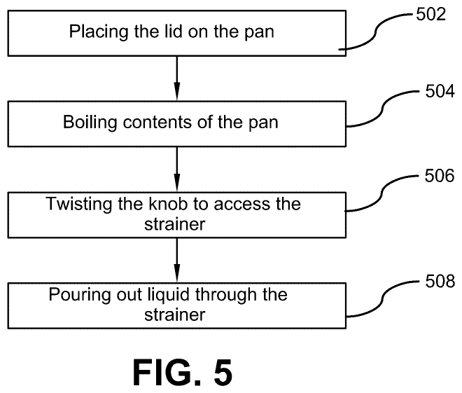

FIG. 5 illustrates a flow chart depicting a process of using the pan with the strainer lid for cooking and straining liquid in accordance with one embodiment of the present invention. Initially, the strainer lid 100 is placed on a pan with ingredients in the pan for cooking (Step 502). The lid 100 is secured to the pan using the silicone rim as described earlier in the disclosure. Then, the pan is used for cooking food item with the lid 100 secured to the pan (Step 504). Thereafter, after or during the cooking, the knob 118 is turned to rotate the pivot arm to open the strainer 120 (Step 506). Finally, the liquid from the pan is poured out by tilting the pan with the secured lid, thereby enabling the liquid to pour out from the strainer (Step 508).

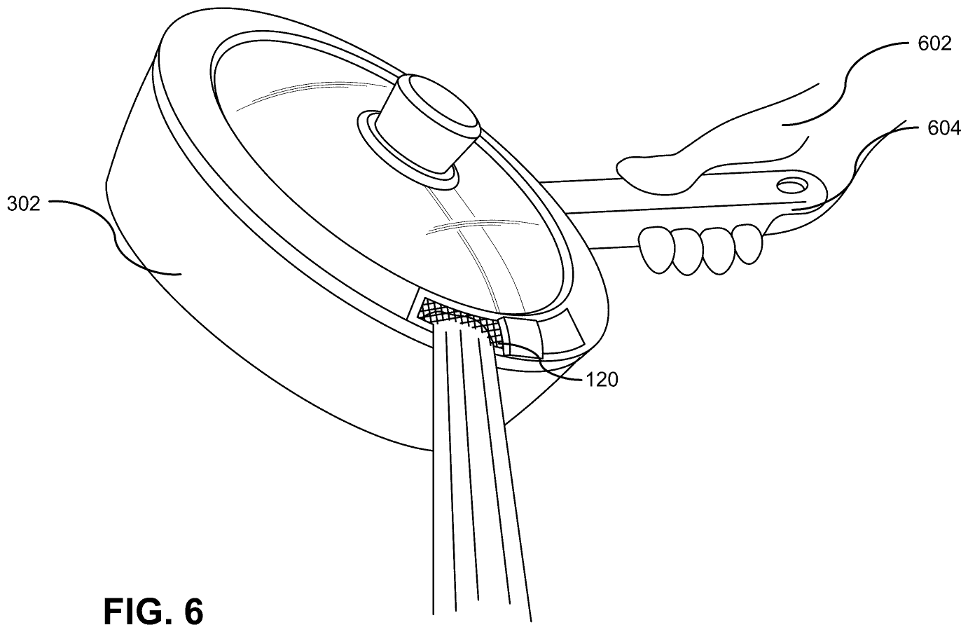

FIG. 6 illustrates a perspective view showing a user using the pan with the strainer lid to pour out liquid from the pan without removing the lid in accordance with one embodiment of the present invention. As illustrated, a user 602 can hold the pan 302 using the handle 604 of the pan 302 and tilt the pan 302 with the secure lid 100 to drain or flush water from the strainer 120. The pan can have sidewalls and a base. The lid 100 does not tilt or displace on the pan 302 and makes it easy for the user to pour out any liquid from the pan 302 while cooking.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “cookware strainer lid, “strainer lid”, and “lid” are interchangeable and refer to the cookware strainer lid 100 of the present invention.

Notwithstanding the forgoing, the cookware strainer lid 100 of the present invention can be of any suitable configuration as is known in the art without affecting the overall concept of the invention, provided that it accomplishes the above stated objectives. One of ordinary skill in the art will appreciate that the cookware strainer lid 100 as shown in the FIGS. are for illustrative purposes only, and that many other configurations of the cookware strainer lid 100 are well within the scope of the present disclosure. Although the dimensions of the cookware strainer lid 100 are important design parameters for user convenience, the cookware strainer lid 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A cookware strainer comprising:
a cookware strainer lid having a lid body and a lid rim; and
a pan;
wherein said lid body having a transparent material;
wherein said lid rim disposed around a periphery of said lid body;
wherein said lid rim sealable to said pan for sealing contents in said pan;
wherein said lid body having an aperture and a twist knob disposed therein proximal to a center of said lid body;
wherein said twist knob turnable bi-directionally in 360 degrees;
wherein said twist knob comprising a heat-resistant material;
wherein said twist knob having a pivot arm operatively connected to said twist knob;
wherein said pivot arm extends from said twist knob to said lid rim;
wherein said pivot arm having a strainer cover at a distal end of said pivot arm;
wherein said strainer cover rotatable adjacent to an inside surface of said lid rim in conjunction with a rotation of said twist knob; and
further wherein said lid rim having a plurality of strainer holes for selectively pouring liquid out from said pan while said cookware strainer lid is attached to said pan.

2. The cookware strainer of claim 1, wherein said twist knob having an axle extending through said lid body to secure said twist knob to said cookware strainer lid and to provide a pivot for rotating said twist knob and a coupled said pivot arm.

3. The cookware strainer of claim 2, wherein said strainer cover selectively aligned with said plurality of strainer holes for covering said plurality of strainer holes.

4. The cookware strainer of claim 3, wherein said strainer cover selectively non-aligned with said plurality of strainer holes for uncovering said plurality of strainer holes.

5. The cookware strainer of claim 4, wherein said transparent material is glass.

6. The cookware strainer of claim 5, wherein said heat-resistant material is silicone.

7. A cookware strainer comprising:
a cookware strainer lid having a lid body and a lid rim; and
a pan;
wherein said lid rim disposed around a periphery of said lid body;
wherein said lid rim sealable to said pan for sealing contents in said pan;
wherein said lid body having an aperture and a twist knob disposed therein proximal to a center of said lid body;
wherein said twist knob turnable bi-directionally in 360 degrees;
wherein said twist knob comprising a heat-resistant material;
wherein said twist knob having a pivot arm operatively connected to said twist knob;
wherein said pivot arm extends from said twist knob to said lid rim;
wherein said pivot arm having a strainer cover at a distal end of said pivot arm;
wherein said lid rim having a plurality of strainer holes for selectively pouring liquid out from said pan while said cookware strainer lid is attached to said pan; and
further wherein said twist knob having an axle extending through said lid body to secure said twist knob to said cookware strainer lid and to provide a pivot for rotating said twist knob and a coupled said pivot arm.

8. The cookware strainer of claim 7, wherein said strainer cover selectively aligned with said plurality of strainer holes for covering said plurality of strainer holes.

9. The cookware strainer of claim 8, wherein said strainer cover selectively non-aligned with said plurality of strainer holes for uncovering said plurality of strainer holes.

10. The cookware strainer of claim 9, wherein said strainer cover rotatable adjacent to an inside surface of said lid rim in conjunction with a rotation of said twist knob.

11. The cookware strainer of claim 10, wherein said lid body having a transparent material.

12. The cookware strainer of claim 11, wherein said transparent material is glass.

13. The cookware strainer of claim 12, wherein said heat-resistant material is silicone.

14. A method of straining a cookware device, the method comprising the steps of:
providing a cookware strainer lid having a lid body, a lid rim, and a pan, wherein said lid rim disposed around a periphery of said lid body, wherein said lid body having an aperture and a twist knob disposed therein proximal to a center of said lid body;
sealing said lid rim to said pan for securing contents in said pan;
selectively turning said twist knob bi-directionally in 360 degrees, wherein said twist knob comprising a heat-resistant material;
operatively connecting said twist knob to a pivot arm, wherein said pivot arm extends from said twist knob to said lid rim, wherein said pivot arm having a strainer cover at a distal end of said pivot arm; further wherein said twist knob having an axle extending through said lid body to secure said twist knob to said cookware strainer lid and to provide a pivot for rotating said twist knob and a coupled said pivot arm;
wherein said lid rim having a plurality of strainer holes; and
selectively pouring liquid out from said pan while said cookware strainer lid is attached to said pan.

15. The method of straining a cookware device of claim 14, wherein said strainer cover selectively aligned with said plurality of strainer holes for covering said plurality of strainer holes.

16. The method of straining a cookware device of claim 15, wherein said strainer cover selectively non-aligned with said plurality of strainer holes for uncovering said plurality of strainer holes.

17. The method of straining a cookware device of claim 16, wherein said strainer cover rotatable adjacent to an inside surface of said lid rim in conjunction with a rotation of said twist knob.

18. The method of straining a cookware device of claim 17, wherein said lid body having a transparent material.

19. The method of straining a cookware device of claim 18, wherein said transparent material is glass.

20. The method of straining a cookware device of claim 19, wherein said heat-resistant material is silicone.
